(19) United States
(12) Patent Application Publication
(10) Pub. No.: US 2025/0392939 A1
(43) Pub. Date: Dec. 25, 2025

(54) PRE-CONFIGURED AND CONCURRENT MEASUREMENT GAP UE BEHAVIOR

(71) Applicant: Intel Corporation, Santa Clara, CA (US)

(72) Inventors: Rui Huang, Beijing (CN); Meng Zhang, Beijing (CN); Hua Li, Beijing 11 (CN); In-Seok Hwang, Santa Clara, CA (US)

(21) Appl. No.: 18/880,678

(22) PCT Filed: Aug. 2, 2023
(86) PCT No.: PCT/US2023/029264

§ 371 Date: Jan. 2, 2025

Related U.S. Application Data
(60) Provisional application No. 63/394,915, filed on Aug. 3, 2022.

(51) Int. Cl. H04W 24/10; H04L 5/00; H04W 24/08; H04W 72/232

(52) U.S. Cl. CPC H04W 24/10; H04L 5/0051; H04W 24/08; H04W 72/232

(57) ABSTRACT

An apparatus and system are described to indicate user equipment (UE) capability on UE measurements with pre-configured measurement gaps (MGs) in new radio systems. The pre-configured MGs may be one or more instances in concurrent MGs. and may be activated/deactivated using downlink control information (DCI). The activated pre-configured MGs may overlap with other MGs and may impact the maximum number of concurrent MGs that are supported by the UE. Overlapping MGs may increase pre-configured gap activation delay.

### PRIORITY CLAIM

This application claims the benefit of priority to U.S. Provisional Patent Application Ser. No. 63/394,915, filed Aug. 3, 2022, which is incorporated herein by reference in its entirety.

### TECHNICAL FIELD

Embodiments pertain to next generation wireless communications. In particular, some embodiments relate to user equipment (UE) behavior under measurement gap (MG) configurations.

### BACKGROUND

The use and complexity of NG systems, which include 5G networks and are starting to include sixth generation (6G) networks among others, has increased due to both an increase in the types of devices user equipment (UEs) using network resources as well as the amount of data and bandwidth being used by various applications, such as video streaming, operating on these UEs. With the vast increase in number and diversity of communication devices, the corresponding network environment has become increasingly complicated. As expected, a number of issues abound with the advent of any new technology, including complexities related to measurement gap behavior.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a joint configuration of pre-MG and concurrent MGs in accordance with some embodiments.

FIG. 4 illustrates a concurrent MG configuration in accordance with some embodiments.

FIG. 5 illustrates a process of identifying signal overlap in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

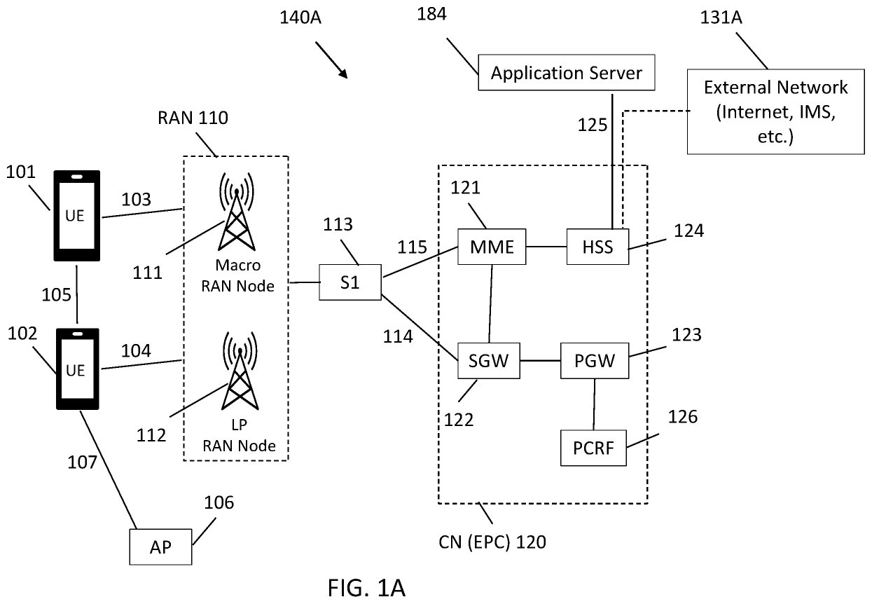

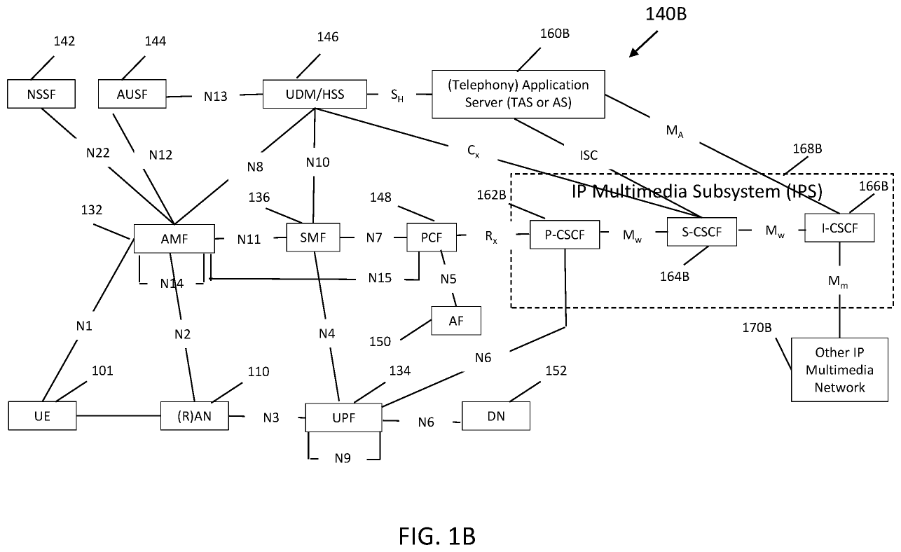

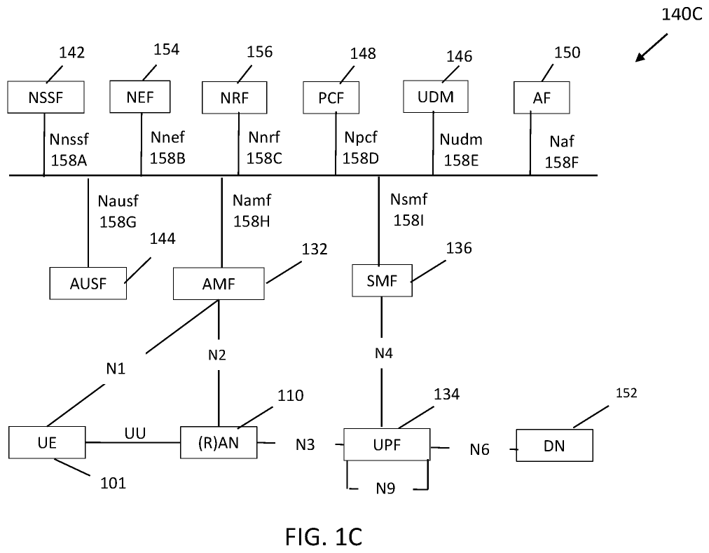

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHz, 3.6-3.8 GHz, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signalling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a primary node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g., an IMS operated by a different network operator.

In some aspects, the UDM/HSS 146 can be coupled to an application server 184, which can include a telephony application server (TAS) or another application server (AS) 160B. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points N1 or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

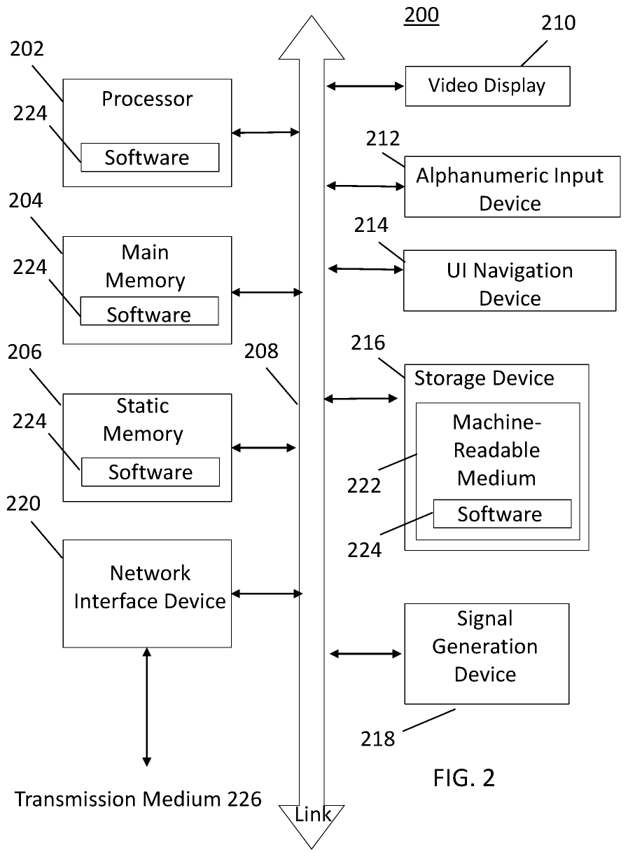

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth (r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHZ, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHZ, 37-38.6 GHZ, 38.6-40 GHz, 42-42.5 GHZ, 57-64 GHz, 71-76 GHz, 81-86 GHz and 92-94 GHz, etc.), the ITS (Intelligent Transport Systems) band of 5.9 GHZ (typically 5.85-5.925 GHZ) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHZ) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, different types of measurement gaps may be used to allow a UE to perform measurements on certain downlink signals, such as signalling system blocks (SSBs) or channel state information reference signals (CSI-RS). The network provides the timing of neighbor cell SSBs using SS/physical broadcast channel (PBCH) Block Measurement Timing Configuration (SMTC). UEs may be able to measure such downlink signals from a neighbor cell when transmitted on the same frequency as data and control signals from/to the serving cell while simultaneously transmitting and receiving these data and control signals. However, for measurements of downlink signals transmitted in different frequency (inter-frequency) or on other radio access technologies (RATs), communications with the serving cell may be suspended while the UE retunes the radio frequency (RF) module to between the different frequencies. Measurement gaps over which the UE is not to transmit or receive signals with the serving cell may thus be used in such cases due to the inability of the UE to simultaneously transmit/receive data and control signals and perform inter-frequency or inter-RAT measurements. Similarly, measurement gaps may be used to permit inter-frequency measurements that are to be performed outside the currently active Bandwidth Part (BWP) used by the UE (intra-frequency measurements). The UE conveys its measurement capabilities to the network in a UE Capability Information message.

A measurement gap configuration may be sent to the UE by the gNB via control signalling, such as Radio Resource Control (RRC) signalling. For example, the RRC Reconfiguration message may contain a MeasConfig information element (IE) that includes a MeasGapConfig IE. Measurement gaps may be periodic and may be specific to the frequency range (e.g., FR1, FR2). The measurement gap configuration may provide a gap period between measurement gap repetitions, a gap offset that specifies the starting subframe of the measurement gap, a measurement gap length (MGL) that specifies the gap duration, a measurement gap timing advance (MGTA) for measurement, and a reference serving cell indicator that indicates the particular cell to use (System Frame Number and subframe numbering) for gap calculation.

In particular, three measurement gap configurations are used in 5G new radio (NR): gapFR1, which is only applied to FR1 communications and is unable to be configured with gapUE; gapFR2, which is only applied to FR2 communications and is unable to be configured with gapUE; and gapUE: which may be applied to all frequencies (the UE is able to measure FR1, FR2 and non-NR RAT signals).

Multiple measurement gaps may be used, including pre-configured measurement gaps (configured by RRC signalling), concurrent measurement gaps, and Network Controlled Small Gaps (NCSG). A measurement gap is configured as pre-configured measurement gap if preConfigInd is indicated by network in the configuration message of the measurement gap. Concurrent gaps are multiple measurement gaps in which each gap pattern may be associated with one or more frequency layers (and may be controlled through RRC signalling or autonomously). When the UE supports concurrent measurement gap pattern capability, the network may provide multiple measurement gaps configured by one or more RRC messages. A NCSG pattern is applicable to a UE configured with standalone (SA) NR (with single carrier or carrier aggregation) operation mode.

A pre-configured measurement gap procedure is used by the network to provide measurement gap for NR downlink positioning reference signal (DL-PRS) measurements. Radio resource management (RRM) requirements may be defined for UEs configured with a combination of pre-configured measurement gaps, and/or multiple concurrent measurement gaps and/or NCSGs. In this case, prioritization of at least joint requirements for a UE configured with: case 1: pre-configured measurement gaps and multiple concurrent measurement gaps (i.e., concurrent measurement gaps where at least one of the gaps is a pre-configured gap); case 2: NCSG and multiple concurrent measurement gaps (i.e., concurrent measurement gaps where at least one of the gaps is a NCSG).

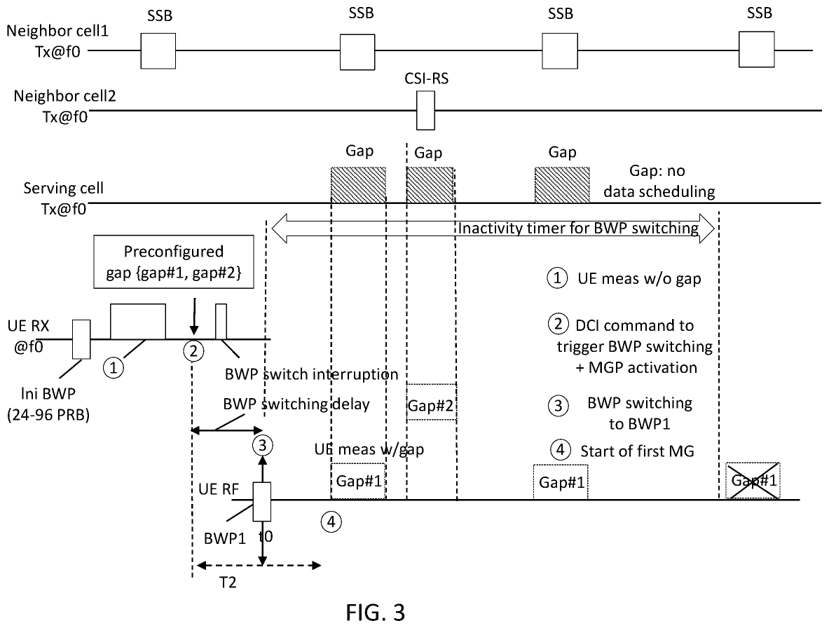

FIG. 3 illustrates a joint configuration of pre-measurement gap and concurrent measurement gaps in accordance with some embodiments. In some embodiments, a pre-configured gap may be used as one instance of a multiple concurrent gap pattern if the UE supports such a pattern, as shown in FIG. 3. As shown, the serving cell and neighbor cells (neighbor cell1, neighbor cell2) transmit at frequency 0 (f0). The serving cell has a measurement gap 1 (GAP #1) with a measurement gap repetition period. During measurement gap 1, neighbor cell1 transmits an SSB at f0, which the UE measures. The serving cell also has a measurement gap2 (GAP #2) for measurement of the CSI-RS of neighbor cell2 at f0, which are transmitted at another measurement gap repetition period and the UE measures.

In FIG. 3, at time 1, the UE may measure the SSB from neighbor cell1 without the use of a measurement gap. At time 2, the UE may receive a physical downlink control channel (PDCCH) having downlink control information (DCI) that triggers switching from the active BWP to BWP1 to measure the SSB from neighbor cell1 with the use of a measurement gap. The DCI may also trigger activation of the measurement gap configuration. At time 3, after a BWP switching delay, the UE may be tuned to BWP1. The measurement gap to measure the SSB from neighbor cell1 may start after a predetermined time T2 after reception of the DCI, where T2 is greater than the time for UE to switch from the active BWP to BWP1. Also at time 3, an inactivity timer (e.g., indicated in the RRC signalling) may be initiated. After termination of the inactivity timer, the UE may no longer employ the pre-configured measurement gap (and may switch back to the original BWP).

Thus, at least one of the gap instances of concurrent gaps GAP #1, GAP #2 may be pre-configured and activated/deactivated when the UE is to perform measurements within the measurement gap.

In some embodiments, concurrent measurement gaps may be pre-configured. Some of the concurrent measurement gaps may be activated dependent on the measurement type within the active BWP of the UE.

Alternatively, only an activated pre-configured measurement gap that is able to overlap with other measurement gaps is counted as an effective concurrent gap instance. This may impact the RRM requirements defined in Rel17 for concurrent gap. First, UE behavior when concurrent measurement gaps are pre-configured is to be redefined. Second, a maximum number of concurrent measurement gaps to be supported may be same as in Rel17, with clarifications shown in Table 9.1.8-1.

TABLE 9.1.8-1
Number of Gap Combination Configurations by UE
supporting both concurrent measurement gap patterns
and independent measurement gap patterns.

The number of simultaneous activated
measurement gap patterns

| | Per-FR1 | Per-FR2 | Per-UE |
|---|---|---|---|
| Gap Combination | measurement | measurement | measurement |
| Configuration Id | gap | gap | gap |
| 0 | 2 | 1 | 0 |
| 1 | 1 | 2 | 0 |
| 2 | 0 | 0 | 2 |
| 3^{Note 1} | 1 | 0 | 1 |
| 4^{Note 1} | 0 | 1 | 1 |
| 5^{Note 1} | 1 | 1 | 1 |

^{Note 1}
Gap Combination Configuration Id #3, #4, #5 will be only applied when the per-UE measurement gap is associated to measure PRS for any RSTD, PRS-RSRP, and UE Rx-Tx time difference measurement defined in TS 38.215 [4].
Note 2:
For gap instances which are pre-configured they shall be activated.

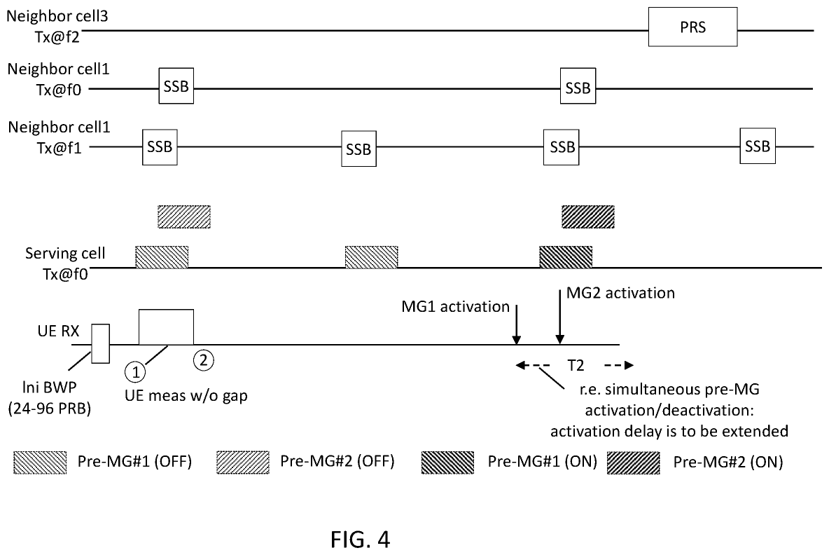

The additional RRM requirements impacted may include a pre-measurement gap activation delay. When multiple activation procedures happen to overlap, an extension on the delay requirements may be used if simultaneous activation is not allowed. Whether simultaneous activation is allowed may be provided by the UE to the gNB in a UE capability message. FIG. 4 illustrates a concurrent measurement gap configuration in accordance with some embodiments. In FIG. 4, the concurrent gaps may be simultaneously activated.

### Per 3GPP TS 38.133

8.19 pre-configured measurement gap activation/deactivation delay applies for a UE configured with a primary cell (PCell) or any activated secondary cell SCell in standalone NR. The UE completes the activation/deactivation of pre-configured measurement gap within the delay.

### 8.19.2 Pre-Configured Measurement Gap Activation/Deactivation Upon DCI/Timer-Based BWP Switch

8.19.2.1 Activation/deactivation upon DCI/timer-based BWP switch delay on a single component carrier (CC) requirements apply to the case that the DCI/timer-based BWP switch is performed on a single CC with more than one BWP configuration configured on the CC. When a BWP switch occurs, which results in status change of pre-configured measurement gap, the UE finishes pre-configured activation or deactivation within 5 ms after the completion of the active BWP switch. Activation/deactivation of Pre-MG takes effect from the first complete MG occasion after the activation and deactivation delay. If the end of activation/deactivation of Pre-MG is within a gap occasion, the Pre-MG status is not immediately changed; instead, the Pre-MG status is changed prior to the next gap occasion.

8.19.3 pre-configured measurement gap activation/deactivation upon SCell activation/deactivation requirements apply when one SCell or multiple SCells are activated/deactivated. When one SCell or multiple SCells are activated/deactivated, which results in status change of pre-configured measurement gap, the UE finishes pre-configured activation or deactivation within 5 ms after the completion of SCell(s) activation/deactivation. Activation/deactivation of the Pre-MG takes effect from the first complete MG occasion after the SCell(s) activation/deactivation delay. If the end of activation/deactivation of the Pre-MG is within a gap occasion, the Pre-MG status is not immediately changed; instead, the Pre-MG status is changed prior to the next gap occasion.

8.19.4 pre-configured measurement gap activation/deactivation upon RRC reconfiguration requirements apply when a UE capable of autonomous activation/deactivation mechanism receives RRC reconfiguration to add/remove of any measurement object(s), add/release/change a SCell under CA, or switch active BWP or update parameters of its active BWP. If the aforementioned RRC reconfiguration results in status change of a pre-configured measurement gap, the UE finishes pre-configured activation or deactivation within 5 ms after an RRC processing delay. If the end of activation/deactivation of Pre-MG is within a gap occasion, the Pre-MG status is not immediately changed; instead, the Pre-MG status is changed prior to the next gap occasion.

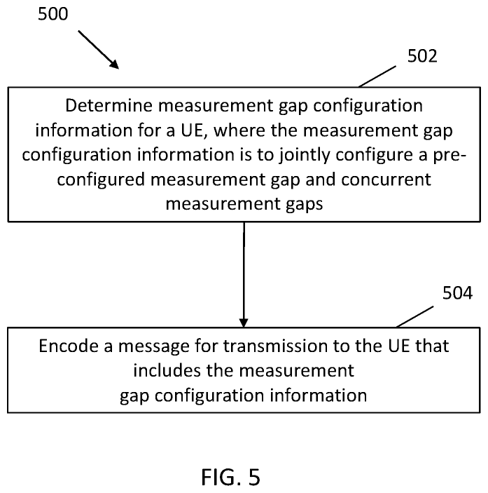

In some embodiments, the electronic devices, networks, systems, chips or components, or portions or implementations thereof, of the above figures may be configured to perform one or more processes, techniques, or methods as described herein, or portions thereof. One such process that may be performed by a UE, one or more elements of a UE, and/or one or more electronic devices that include or implement one or more elements of a UE is depicted in FIG. 5. FIG. 5 illustrates a process of identifying signal overlap in accordance with some embodiments. The process 500 may include determining, at operation 502, measurement gap configuration information for a UE; and encoding, at operation 504, a message for transmission to the UE that includes the measurement gap configuration information. The measurement gap configuration information is to jointly configure a pre-configured measurement gap and concurrent measurement gaps.
Per TS 38.331:

### 5.5.2.9 Measurement Gap Configuration

The UE shall:
1> if gapFR1 is set to setup:
   2> if an FR1 measurement gap configuration is already setup, release the FR1 measurement gap configuration;
   2> setup the FRI measurement gap configuration indicated by the measGapConfig in accordance with the received gapOffset, i.e., the first subframe of each gap occurs at an SFN and subframe meeting the following condition:

$$SFN mod T = FLOOR ( gapOffset / 10 ) ; \qquad [ 14 ]$$

$$subframe = gapOffset mod 10 ;$$

$$with T = MGRP / 10 as defined in TS 38.133 ;$$

2> apply the specified timing advance mgta to the gap occurrences calculated above (i.e. the UE starts the measurement mgta ms before the gap subframe occurrences);
1> else if gapFR1 is set to release:
   2> release the FR1 measurement gap configuration;
1> if gapFR2 is set to setup:
   2> if an FR2 measurement gap configuration is already setup, release the FR2 measurement gap configuration;
   2> setup the FR2 measurement gap configuration indicated by the measGapConfig in accordance with the received gapOffset, i.e., the first subframe of each gap occurs at an SFN and subframe meeting the following condition:

$$SFN mod T = FLOOR ( gapOffset / 10 ) ; \qquad [ 14 ]$$

$$subframe = gapOffset mod 10 ;$$

$$with T = MGRP / 10 as defined in TS 38.133 ;$$

2> apply the specified timing advance mgta to the gap occurrences calculated above (i.e. the UE starts the measurement mgta ms before the gap subframe occurrences);
1> else if gapFR2 is set to release:
   2> release the FR2 measurement gap configuration;
1> if gapUE is set to setup:
   2> if a per UE measurement gap configuration is already setup, release the per UE measurement gap configuration;
   2> setup the per UE measurement gap configuration indicated by the measGapConfig in accordance with the received gapOffset, i.e., the first subframe of each gap occurs at an SFN and subframe meeting the following condition:

$$SFN mod T = FLOOR ( gapOffset / 10 ) ; \qquad [ 14 ]$$

$$subframe = gapOffset mod 10 ;$$

$$with T = MGRP / 10 as defined in TS 38.133 ;$$

2> apply the specified timing advance mgta to the gap occurrences calculated above (i.e. the UE starts the measurement mgta ms before the gap subframe occurrences);
1> else if gapUE is set to release:
   2> release the per UE measurement gap configuration.

Also, per TS 38.331, the IE MeasConfig specifies measurements to be performed by the UE, and covers intra-frequency, inter-frequency and inter-RAT mobility as well as configuration of measurement gaps.

MeasConfig information element

-- ASN1START
-- TAG-MEASCONFIG-START

| | |
|---|---|
| MeasConfig ::= | SEQUENCE { |

| | |
|---|---|
| measObjectToRemoveList | MeasObjectToRemoveList |

| | |
|---|---|
| OPTIONAL, | -- Need N |

| | |
|---|---|
| measObjectToAddModList | MeasObjectToAddModList |

| | |
|---|---|
| OPTIONAL, | -- Need N |

| | |
|---|---|
| reportConfigToRemoveList | ReportConfigToRemoveList |

| | |
|---|---|
| OPTIONAL, | -- Need N |

| | |
|---|---|
| reportConfigToAddModList | ReportConfigToAddModList |

| | |
|---|---|
| OPTIONAL, | -- Need N |

| | |
|---|---|
| measIdToRemoveList | MeasIdToRemoveList |

| | |
|---|---|
| OPTIONAL, | -- Need N |

| | |
|---|---|
| measIdToAddModList | MeasIdToAddModList |

| | |
|---|---|
| OPTIONAL, | -- Need N |

| | |
|---|---|
| s-MeasureConfig | CHOICE { |
| ssb-RSRP | RSRP-Range, |
| csi-RSRP | RSRP-Range |

| | |
|---|---|
| } | OPTIONAL, |

-- Need M

| | |
|---|---|
| quantityConfig | QuantityConfig |

| | |
|---|---|
| OPTIONAL, | -- Need M |

| | |
|---|---|
| measGapConfig | MeasGapConfig |

| | |
|---|---|
| OPTIONAL, | -- Need M |

| | |
|---|---|
| measGapSharingConfig | MeasGapSharingConfig |

| | |
|---|---|
| OPTIONAL, | -- Need M |

```
  ...,
  [[
```

| | |
|---|---|
| interFrequencyConfig-NoGap-r16 | ENUMERATED {true} |

| | |
|---|---|
| OPTIONAL | -- Need R |

]]
}

| | |
|---|---|
| MeasObjectToRemoveList ::= | SEQUENCE (SIZE |

(1..maxNrofObjectId)) OF MeasObjectId

| | |
|---|---|
| MeasIdToRemoveList ::= | SEQUENCE (SIZE (1..maxNrofMeasId)) |

OF MeasId

| | |
|---|---|
| ReportConfigToRemoveList ::= | SEQUENCE (SIZE |

(1..maxReportConfigId)) OF ReportConfigId
-- TAG-MEASCONFIG-STOP
-- ASN1STOP

MeasConfig field descriptions

inter FrequencyConfig-NoGap-r16
If the field is set to true, UE is configured to perform SSB based
inter-frequency measurement without measurement gaps when the inter-
frequency SSB is completely contained in the active DL BWP of the
UE, as specified in TS 38.133 [14], clause 9.3. Otherwise, the SSB
based inter-frequency measurement is performed within measurement
gaps.
measGapConfig
Used to setup and release measurement gaps in NR.
measIdToAddModList
List of measurement identities to add and/or modify.
measIdToRemoveList
List of measurement identities to remove.
measObjectToAddModList
List of measurement objects to add and/or modify.
measObjectToRemoveList
List of measurement objects to remove.
reportConfigToAddModList
List of measurement reporting configurations to add and/or modify.
reportConfigToRemoveList
List of measurement reporting configurations to remove.
s-MeasureConfig
Threshold for NR SpCell RSRP measurement controlling when the UE is
required to perform measurements on non-serving cells. Choice of ssb-
RSRP corresponds to cell RSRP based on SS/PBCH block and choice of
csi-RSRP corresponds to cell RSRP of CSI-RS.
measGapSharingConfig
Specifies the measurement gap sharing scheme and controls setup/release
of measurement gap sharing

The IE MeasGapConfig specifies the measurement gap configuration and controls setup/release of measurement gaps.

MeasGapConfig information element

-- ASN1START
-- TAG-MEASGAPCONFIG-START

| | |
|---|---|
| MeasGapConfig ::= | SEQUENCE { |
| gapFR2 | SetupRelease { GapConfig } |

| | |
|---|---|
| OPTIONAL, | -- Need M |

```
  ...,
  [[
```

| | |
|---|---|
| gapFR1 | SetupRelease { GapConfig } |

| | |
|---|---|
| OPTIONAL, | -- Need M |

| | |
|---|---|
| gapUE | SetupRelease { GapConfig } |

| | |
|---|---|
| OPTIONAL | -- Need M |

]]
}

| | |
|---|---|
| GapConfig ::= | SEQUENCE { |
| gapOffset | INTEGER (0..159), |
| mgl | ENUMERATED {ms1dot5, ms3, ms3dot5, ms4, |

ms5dot5, ms6},

| | |
|---|---|
| mgrp | ENUMERATED {ms20, ms40, ms80, ms160}, |
| mgta | ENUMERATED {ms0, ms0dot25, ms0dot5}, |

```
  ...,
  [[
```

| | |
|---|---|
| refServCellIndicator | ENUMERATED {pCell, pSCell, mcg-FR2} |

| | |
|---|---|
| OPTIONAL | -- Cond NEDCorNRDC |

```
  ]],
  [[
```

| | |
|---|---|
| refFR2ServCellAsyncCA-r16 | ServCellIndex |

| | |
|---|---|
| OPTIONAL, | -- Cond AsyncCA |

| | |
|---|---|
| mgl-r16 | ENUMERATED {ms10, ms20} |

| | |
|---|---|
| OPTIONAL | -- Cond PRS |

]]
}
-- TAG-MEASGAPCONFIG-STOP
-- ASN1STOP

MeasGapConfig field descriptions

gapFR1
Indicates measurement gap configuration that applies to FR1 only. In
(NG)EN-DC, gapFR1 cannot be set up by NR RRC (i.e. only LTE RRC
can configure FR1 measurement gap). In NE-DC, gapFR1 can only be set
up by NR RRC (i.e. LTE RRC cannot configure FR1 gap). In NR-DC,
gapFR1 can only be set up in the measConfig associated with MCG.
gapFR1 can not be configured together with gapUE. The applicability
of the FR1 measurement gap is according to Table 9.1.2-2 and
Table 9.1.2-3 in TS 38.133 [14].
gapFR2
Indicates measurement gap configuration applies to FR2 only. In
(NG)EN-DC or NE-DC, gapFR2 can only be set up by NR RRC (i.e.
LTE RRC cannot configure FR2 gap). In NR-DC, gapFR2 can only be
set up in the measConfig associated with MCG. gapFR2 cannot be
configured together with gapUE. The applicability of the FR2
measurement gap is according to Table 9.1.2-2 and Table 9.1.2-3
in TS 38.133 [14].
gapUE
Indicates measurement gap configuration that applies to all frequencies
(FR1 and FR2). In (NG)EN-DC, gapUE cannot be set up by NR RRC (i.e.
only LTE RRC can configure per UE measurement gap). In NE-DC,
gapUE can only be set up by NR RRC (i.e. LTE RRC cannot configure
per UE gap). In NR-DC, gapUE can only be set up in the measConfig
associated with MCG. If gapUE is configured, then neither gapFR1
nor gapFR2 can be configured. The applicability of the per UE
measurement gap is according to Table 9.1.2-2 and Table 9.1.2-3 in
TS 38.133 [14].
gapOffset
Value gapOffset is the gap offset of the gap pattern with MGRP indicated
in the field mgrp. The value range is from 0 to mgrp-1
mgl
Value mgl is the measurement gap length in ms of the measurement gap.
The measurement gap length is according to in Table 9.1.2-1 in TS 38.133
[14]. Value msldot5 corresponds to 1.5 ms, ms3 corresponds to 3 ms
and so on. If mgl-r 16 is present, UE shall ignore the mgl (without suffix).
mgrp
Value mgrp is measurement gap repetition period in (ms) of the
measurement gap. The measurement gap repetition period is according to
Table 9.1.2-1 in TS 38.133 [14].
mgta
Value mgta is the measurement gap timing advance in ms. The
applicability of the measurement gap timing advance is according to
clause 9.1.2 of TS 38.133 [14]. Value ms0 corresponds to 0 ms,
ms0dot25 corresponds to 0.25 ms and ms0dot5 corresponds to 0.5 ms. For
FR2, the network only configures 0 ms and 0.25 ms.
refFR2ServCellAsyncCA
Indicates the FR2 serving cell identifier whose SFN and subframe is
used for FR2 gap calculation for this gap pattern with asynchronous
CA involving FR2 carrier(s).
refServCellIndicator
Indicates the serving cell whose SFN and subframe are used for gap
calculation for this gap pattern. Value pCell corresponds to the PCell,
pSCell corresponds to the PSCell, and mcg-FR2 corresponds to a serving
cell on FR2 frequency in MCG.

| Conditional | |
|---|---|
| Presence | Explanation |
| AsyncCA | This field is mandatory present when configuring FR2 |
| | gap pattern to UE in: |
| | (NG)EN-DC or NR SA with asynchronous CA |
| | involving FR2 carrier(s); |
| | NE-DC or NR-DC with asynchronous CA |
| | involving FR2 carrier(s), if the field |
| | refServCellIndicator is set to mcg-FR2. |
| | In case the gap pattern to UE in NE-DC and NR-DC is |
| | already configured and the serving cell used for the gap |
| | calculation corresponds to a serving cell on FR2 |
| | frequency in MCG, then the field is optionally present, |
| | need M. Otherwise, it is absent, Need R. |
| NEDCorNRDC | This field is mandatory present when configuring gap |
| | pattern to UE in NE-DC or NR-DC. In case the gap |
| | pattern to UE in NE-DC and NR-DC is already |
| | configured, then the field is absent, need M. Otherwise, |
| | it is absent. |
| PRS | This field is optionally present, Need R, when |
| | configuring gap pattern to UE for measurements of |
| | DL-PRS configured via LPP (TS 37.355 [49]). |
| | Otherwise, it is absent. |

The IE MeasGapSharingConfig specifies the measurement gap sharing scheme and controls setup/release of measurement gap sharing.

### MeasGapSharingConfig Information Element

MeasGapSharingConfig information element

| -- ASN1START | |
|---|---|
| -- TAG-MEASGAPSHARINGCONFIG-START | |
| MeasGapSharingConfig ::= | SEQUENCE { |
| gapSharingFR2 | SetupRelease { MeasGapSharingScheme } |

| | |
|---|---|
| OPTIONAL, | -- Need M |

| ..., | |
|---|---|
| [[ | |
| gapSharingFR1 | SetupRelease { MeasGapSharingScheme } |

| | |
|---|---|
| OPTIONAL, | -- Need M |

| | |
|---|---|
| gapSharingUE | SetupRelease { MeasGapSharingScheme } |

| | |
|---|---|
| OPTIONAL | -- Need M |

| ]] | |
|---|---|
| } | |
| MeasGapSharingScheme ::= | ENUMERATED {scheme00, scheme01, |

scheme10, scheme11}
-- TAG-MEASGAPSHARINGCONFIG-STOP
-- ASN1STOP

MeasGapSharingConfig field descriptions

gapSharingFR1
Indicates the measurement gap sharing scheme that applies to the gap set
for FR1 only. In (NG)EN-DC, gapSharingFR1 cannot be set up by NR
RRC (i.e. only LTE RRC can configure FR1 gap sharing). In NE-DC,
gapSharingFR1 can only be set up by NR RRC (i.e. LTE RRC cannot
configure FR1 gap sharing). In NR-DC, gapSharingFR1 can only be set
up in the measConfig associated with MCG. gapSharingFR1 can not be
configured together with gapSharingUE. For the applicability of the
different gap sharing schemes, see TS 38.133 [14]. Value scheme00
corresponds to scheme “00”, value scheme01 corresponds to scheme
“01”, and so on.
gapSharingFR2
Indicates the measurement gap sharing scheme that applies to the gap set
for FR2 only. In (NG)EN-DC or NE-DC, gapSharingFR2 can only be set
up by NR RRC (i.e. LTE RRC cannot configure FR2 gap sharing). In
NR-DC, gapSharingFR2 can only be set up by MCG in the measConfig
associated with MCG. gapSharingFR2 cannot be configured together with
gapSharingUE. For applicability of the different gap sharing schemes,
see TS 38.133 [14]. Value scheme00 corresponds to scheme
“00”, value scheme01 corresponds to scheme “01”, and so on.
gapSharingUE
Indicates the measurement gap sharing scheme that applies to the gap set
per UE. In (NG)EN-DC, gapSharingUE cannot be set up by NR RRC (i.e.
only LTE RRC can configure per UE gap sharing). In NE-DC,
gapSharingUE can only be set up by NR RRC (i.e. LTE RRC cannot
configure per UE gap sharing). In NR-DC, gapSharingUE can only be set
up in the measConfig associated with MCG. If gapSharingUE is
configured, then neither gapSharingFR1 nor gapSharingFR2 can be
configured. For the applicability of the different gap sharing schemes,
see TS 38.133 [14]. Value scheme00 corresponds to scheme “00”,
value scheme01 corresponds to scheme “01”, and so on.

In some embodiments, the concurrent gap patterns can be configured individually depending on the property of the reference signal to be measured and UE RF operations. That is regarding to the reference signals to be measured within the concurrent gap patterns are same as these defined in Rel16 (e.g., SSB, CSI-RS or PRS), the current gap patterns that are applicable per UE in Rel15/Rel16 can be reused for these multiple gap patterns.

### EXAMPLES

Example 1 is an apparatus for a user equipment (UE), the apparatus comprising: processing circuitry to configure the UE to: receive, from a serving cell, radio resource control (RRC) signalling that comprises a measurement gap pattern configuration for each of a plurality of neighbor cells, the RRC signalling jointly configuring a pre-configured measurement gap and concurrent measurement gaps in which at least one of the concurrent measurement gaps is the pre-configured measurement gap; determine whether at least one of the pre-configured measurement gap and concurrent measurement gaps is active; and perform a measurement on a downlink signal from at least one of the neighbor cells based on a determination that the at least one of the pre-configured measurement gap and concurrent measurement gaps is active; and a memory configured to store the RRC signalling.

In Example 2, the subject matter of Example 1 includes, wherein the processing circuitry configures the UE to: receive downlink control information (DCI); and based on the DCI, determine that the at least one of the pre-configured measurement gap and concurrent measurement gaps is active and switch from an originally active bandwidth part (BWP) to another BWP.

In Example 3, the subject matter of Example 2 includes, wherein based on the DCI, the processing circuitry configures the UE to measure a signalling system block (SSB) from one of the neighbor cells using one of the at least one of the pre-configured measurement gap and concurrent measurement gaps, and channel state information reference signals (CSI-RS) using another of the at least one of the pre-configured measurement gap and concurrent measurement gaps.

In Example 4, the subject matter of Examples 2-3 includes, wherein based on the DCI, the processing circuitry configures the UE to start an inactivity timer for BWP switching and, in response to termination of the inactivity timer, switch back from the other BWP to the originally active BWP.

In Example 5, the subject matter of Examples 1˜4 includes, wherein the processing circuitry is further configured to determine a maximum number of concurrent measurement gaps based on a number of activated pre-configured measurement gaps.

In Example 6, the subject matter of Example 5 includes, wherein the processing circuitry is further configured to determine a number of gap combination configurations that support concurrent measurement gap patterns and independent measurement gap patterns, including per-frequency range1 (FR1) measurement gaps, per-frequency range2 (FR2) measurement gaps, and per-UE measurement gaps, as:

Number of simultaneous activated
measurement gap patterns

| Gap Combination | Per-FR1 | Per-FR2 | Per-UE |
|---|---|---|---|
| Configuration | measurement | measurement | measurement |
| identity (ID) | gap | gap | gap |
| 0 | 2 | 1 | 0 |
| 1 | 1 | 2 | 0 |
| 2 | 0 | 0 | 2 |
| 3 | 1 | 0 | 1 |
| 4 | 0 | 1 | 1 |
| 5 | 1 | 1 | 1 |

wherein gap combination configuration ID 3, 4, 5 is applied when a per-UE measurement gap is associated to measure a positioning reference signal (PRS) for a reference-signal-time-difference (RSTD), PRS-RSRP, or UE reception-transmission (Rx-Tx) time difference measurement.

In Example 7, the subject matter of Examples 1-6 includes, wherein the processing circuitry is further configured to: determine whether simultaneous activation of measurement gaps is allowed; determine whether the at least one of the pre-configured measurement gap and concurrent measurement gaps has been activated and overlap; and in response to a determination that simultaneous activation of measurement gaps is not allowed and that the at least one of the pre-configured measurement gap and concurrent measurement gaps has been activated and overlap, use an extended pre-measurement gap activation delay after activation of the at least one of the pre-configured measurement gap and concurrent measurement gaps.

In Example 8, the subject matter of Example 7 includes, wherein the processing circuitry is further configured to indicate in a UE capability message whether simultaneous activation of measurement gaps is allowed.

Example 9 is an apparatus for a 5th generation NodeB (gNB), the apparatus comprising: processing circuitry to configure the gNB to: send, to a user equipment (UE), radio resource control (RRC) signalling that comprises a measurement gap pattern configuration for each of a plurality of neighbor cells, the RRC signalling jointly configuring a pre-configured measurement gap and concurrent measurement gaps in which at least one of the concurrent measurement gaps is the pre-configured measurement gap; send, to the UE, downlink control information (DCI) that indicates the at least one of the pre-configured measurement gap and concurrent measurement gaps is active and to switch from an originally active bandwidth part (BWP) to another BWP; and receive, from the UE, measurements on a downlink signal from the neighbor cells based on a determination that the at least one of the pre-configured measurement gap and concurrent measurement gaps is active; and a memory configured to store the RRC signalling.

In Example 10, the subject matter of Example 9 includes, wherein the measurements comprise measurement of a signalling system block (SSB) from one of the neighbor cells using one of the at least one of the pre-configured measurement gap and concurrent measurement gaps and measurement of channel state information reference signals (CSI-RS) using another of the at least one of the pre-configured measurement gap and concurrent measurement gaps.

In Example 11, the subject matter of Examples 9-10 includes, wherein the DCI is configured to trigger initiation of an inactivity timer for BWP switching and, in response to termination of the inactivity timer, switch back from the other BWP to the originally active BWP.

In Example 12, the subject matter of Examples 9-11 includes, wherein a maximum number of concurrent measurement gaps is based on a number of activated pre-configured measurement gaps.

In Example 13, the subject matter of Example 12 includes, wherein a number of gap combination configurations that support concurrent measurement gap patterns and independent measurement gap patterns, including per-frequency range1 (FR1) measurement gaps, per-frequency range2 (FR2) measurement gaps, and per-UE measurement gaps, are:

Number of simultaneous activated
measurement gap patterns

| Gap Combination | Per-FR1 | Per-FR2 | Per-UE |
|---|---|---|---|
| Configuration | measurement | measurement | measurement |
| identity (ID) | gap | gap | gap |
| 0 | 2 | 1 | 0 |
| 1 | 1 | 2 | 0 |
| 2 | 0 | 0 | 2 |
| 3 | 1 | 0 | 1 |
| 4 | 0 | 1 | 1 |
| 5 | 1 | 1 | 1 |

wherein gap combination configuration ID 3, 4, 5 is applied when a per-UE measurement gap is associated to measure a positioning reference signal (PRS) for a reference-signal-time-difference (RSTD), PRS-RSRP, or UE reception-transmission (Rx-Tx) time difference measurement.

In Example 14, the subject matter of Examples 9-13 includes, wherein the RRC signalling indicates an extended pre-measurement gap activation delay after simultaneous activation and overlap of the at least one of the pre-configured measurement gap and concurrent measurement gaps.

In Example 15, the subject matter of Example 14 includes, wherein the processing circuitry is further configured to receive, in a UE capability message, whether simultaneous activation of measurement gaps is supported by the UE.

Example 16 is a non-transitory computer-readable storage medium that stores instructions for execution by one or more processors of a user equipment (UE), the one or more processors to configure the UE to, when the instructions are executed: receive, from a serving cell, radio resource control (RRC) signalling that comprises a measurement gap pattern configuration for each of a plurality of neighbor cells, the RRC signalling jointly configuring a pre-configured measurement gap and concurrent measurement gaps in which at least one of the concurrent measurement gaps is the pre-configured measurement gap; receive downlink control information (DCI); based on the DCI, determine that at least one of the pre-configured measurement gap and concurrent measurement gaps is active and switch from an originally active bandwidth part (BWP) to another BWP; and perform a measurement on a downlink signal from at least one of the neighbor cells.

In Example 17, the subject matter of Example 16 includes, wherein when the instructions are executed the one or more processors configure the UE to, based on the DCI, measure a signalling system block (SSB) from one of the neighbor cells using one of the at least one of the pre-configured measurement gap and concurrent measurement gaps, and channel state information reference signals (CSI-RS) using another of the at least one of the pre-configured measurement gap and concurrent measurement gaps.

In Example 18, the subject matter of Examples 16-17 includes, wherein when the instructions are executed the one or more processors configure the UE to, based on the DCI, start an inactivity timer for BWP switching and, in response to termination of the inactivity timer, switch back from the other BWP to the originally active BWP.

In Example 19, the subject matter of Examples 16-18 includes wherein when the instructions are executed the one or more processors configure the UE to determine a maximum number of concurrent measurement gaps based on a number of activated pre-configured measurement gaps, a number of gap combination configurations that support concurrent measurement gap patterns and independent measurement gap patterns, including per-frequency range1 (FR1) measurement gaps, per-frequency range2 (FR2) measurement gaps, and per-UE measurement gaps, determined as:

Number of simultaneous activated
measurement gap patterns

| Gap Combination | Per-FR1 | Per-FR2 | Per-UE |
|---|---|---|---|
| Configuration | measurement | measurement | measurement |
| identity (ID) | gap | gap | gap |
| 0 | 2 | 1 | 0 |
| 1 | 1 | 2 | 0 |
| 2 | 0 | 0 | 2 |
| 3 | 1 | 0 | 1 |
| 4 | 0 | 1 | 1 |
| 5 | 1 | 1 | 1 |

wherein gap combination configuration ID 3, 4, 5 is applied when a per-UE measurement gap is associated to measure a positioning reference signal (PRS) for a reference-signal-time-difference (RSTD), PRS-RSRP, or UE reception-transmission (Rx-Tx) time difference measurement.

In Example 20, the subject matter of Examples 16-19 includes, wherein when the instructions are executed the one or more processors configure the UE to: determine whether simultaneous activation of measurement gaps is allowed; determine whether the at least one of the pre-configured measurement gap and concurrent measurement gaps has been activated and overlap; and in response to a determination that simultaneous activation of measurement gaps is not allowed and that the at least one of the pre-configured measurement gap and concurrent measurement gaps has been activated and overlap, use an extended pre-measurement gap activation delay after activation of the at least one of the pre-configured measurement gap and concurrent measurement gaps.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-40. (canceled)

41. A user equipment (UE) comprising:
processing circuitry configured to:
receive, from a serving cell, radio resource control (RRC) signaling that includes a configuration of multiple measurement gap patterns, at least one of the measurement gap patterns being a pre-configured measurement gap pattern;
determine, for each of a plurality of frequency layers, an association between the frequency layer and one of the measurement gap patterns;
autonomously activate or deactivate the pre-configured measurement gap pattern based on measurement objects associated with the pre-configured measurement gap pattern, wherein each measurement gap pattern is considered a simultaneously configured measurement gap pattern only when the measurement gap pattern is activated, and only activated measurement gap patterns are used for performing measurements in parallel;
in response to a determination that the pre-configured measurement gap pattern is active, perform a measurement on a downlink signal from a neighbor cell within a measurement gap occasion of the pre-configured measurement gap pattern; and
a memory configured to store the measurement.

42. The user equipment of claim 41, wherein the processing circuitry is further configured to determine a maximum number of concurrent measurement gap patterns based on a number of activated pre-configured measurement gaps.

43. The user equipment of claim 41, wherein the processing circuitry is further configured to determine a number of gap combination configurations that support concurrent range 1 (FR1) measurement gaps, per-frequency range 2 (FR2) measurement gaps, and per-UE measurement gaps, as specified in Table 9.1.12-1 of TS 38.133.

44. The user equipment of claim 41, wherein the processing circuitry is further configured to, in response to a determination that simultaneous activation of measurement gaps is not allowed and that at least one pre-configured measurement gap and another concurrent measurement gap have been activated and overlap, use a pre-measurement gap activation delay after activation of the at least one pre-configured measurement gap and concurrent measurement gap.

45. The user equipment of claim 41, wherein the processing circuitry is configured to receive downlink control information (DCI) and, based on the DCI, determine that at least one of the pre-configured measurement gap and concurrent measurement gaps is active and switch from an originally active bandwidth part (BWP) to another BWP.

46. The user equipment of claim 45, wherein, based on the DCI, the processing circuitry is configured to measure a signaling system block (SSB) from one of the neighbor cells using one of the at least one of the pre-configured measurement gap and concurrent measurement gaps, and channel state information reference signals (CSI-RS) using another of the at least one of the pre-configured measurement gap and concurrent measurement gaps.

47. The user equipment of claim 45, wherein, based on the DCI, the processing circuitry is configured to start a timer for BWP switching and, in response to termination of the timer, switch back from the other BWP to the originally active BWP.

48. The user equipment of claim 45, wherein the processing circuitry is further configured to indicate in a UE capability message whether simultaneous activation of measurement gaps is allowed.

49. The user equipment of claim 45, wherein the processing circuitry is further configured to perform the measurement on a downlink signal from a neighbor cell based on a determination that the at least one of the pre-configured measurement gap and concurrent measurement gaps is active.

50. The user equipment of claim 41, wherein the processing circuitry is further configured to receive, for each frequency layer, a gap association indication from a network via associatedMeasGapSSB-r17, associatedMeasGapCSIRS-r17, or gapAssociationPRS-r17.

51. The user equipment of claim 41, wherein, in response to a collision between two measurement gap occasions, the processing circuitry is configured to perform measurements in a measurement gap occasion with higher priority.

52. The user equipment of claim 41, wherein the processing circuitry is further configured to associate each measurement object with a specific measurement gap pattern.

53. The user equipment of claim 41, wherein, when both autonomous and network-controlled mechanisms for activation or deactivation of the pre-configured measurement gap pattern are supported, the processing circuitry is configured to use the network-controlled mechanism in response to reception of an activation or deactivation status via RRC indication preConfGapStatus.

54. A non-transitory computer-readable storage medium that stores instructions for execution by one or more processors of a user equipment (UE), the one or more processors to configure the UE to, when the instructions are executed:
receive, from a serving cell, radio resource control (RRC) signaling that includes configuration of multiple measurement gap patterns, at least one of the measurement gap patterns being a pre-configured measurement gap pattern;
determine, for each of a plurality of frequency layers, an association between the frequency layer and one of the measurement gap patterns;
autonomously activate the pre-configured measurement gap pattern based on measurement objects associated with the pre-configured measurement gap pattern, wherein each measurement gap pattern is considered a simultaneously configured measurement gap pattern only when the measurement gap pattern is activated, and only activated measurement gap patterns are used for performing measurements in parallel; and
in response to a determination that the pre-configured measurement gap pattern is active, perform a measurement on a downlink signal from a neighbor cell within a measurement gap occasion of the pre-configured measurement gap pattern.

55. The non-transitory computer-readable storage medium of claim 54, wherein the instructions, when executed by the one or more processors, configure the UE to determine a maximum number of concurrent measurement gap patterns based on a number of activated pre-configured measurement gaps.

56. The non-transitory computer-readable storage medium of claim 54, wherein the instructions, when executed by the one or more processors, configure the UE to determine a number of gap combination configurations that support concurrent measurement gap patterns and independent measurement gap patterns, including per-frequency range 1 (FR1) measurement gaps, per-frequency range 2 (FR2) measurement gaps, and per-UE measurement gaps, as specified in Table 9.1.12-1 of TS 38.133.

57. The non-transitory computer-readable storage medium of claim 54, wherein the instructions, when executed by the one or more processors, configure the UE to, in response to a determination that simultaneous activation of measurement gaps is not allowed and that at least one pre-configured measurement gap and another concurrent measurement gap have been activated and overlap, use a pre-measurement gap activation delay after activation of the at least one pre-configured measurement gap and concurrent measurement gap.

58. The non-transitory computer-readable storage medium of claim 54, wherein the instructions, when executed by the one or more processors, configure the UE to receive downlink control information (DCI) and, based on the DCI, determine that at least one of the pre-configured measurement gap and concurrent measurement gaps is active and switch from an originally active bandwidth part (BWP) to another BWP.

59. A user equipment (UE) comprising:
memory; and processing circuitry configured to:
receive, from a serving cell, radio resource control (RRC) signaling that includes configuration of multiple measurement gap patterns, at least one of the measurement gap patterns being a pre-configured measurement gap pattern;
autonomously activate the pre-configured measurement gap pattern based on measurement objects associated with the pre-configured measurement gap pattern, wherein each measurement gap pattern is considered a simultaneously configured measurement gap pattern only when the measurement gap pattern is activated, and only activated measurement gap patterns are used for performing measurements in parallel;
perform a measurement on a downlink signal from a neighbor cell within a measurement gap occasion of an associated measurement gap pattern when the associated measurement gap pattern is active; and
in response to a determination that simultaneous activation of measurement gaps is not allowed and that at least one pre-configured measurement gap and another concurrent measurement gap have been activated and overlap, use a pre-measurement gap activation delay after activation of the at least one pre-configured measurement gap and concurrent measurement gap; and
a memory configured to store the measurement.

60. The user equipment of claim 59, wherein the processing circuitry is further configured to:
determine a maximum number of concurrent measurement gap patterns based on a number of activated pre-configured measurement gaps,
determine a number of gap combination configurations that support concurrent range 1 (FR1) measurement gaps, per-frequency range 2 (FR2) measurement gaps, and per-UE measurement gaps, as specified in Table 9.1.12-1 of TS 38.133, and
receive downlink control information (DCI) and, based on the DCI, determine that at least one of the pre-configured measurement gap and concurrent measurement gaps is active and switch from an originally active bandwidth part (BWP) to another BWP.
